(19) United States
(12) Patent Application Publication
(10) Pub. No.: US 2004/0056957 A1
(43) Pub. Date: Mar. 25, 2004

(54) System and method for capturing images based upon subject orientation

(76) Inventors: John Christopher Crandall, Fort Collins, CO (US); Carla Amanda Pasetti, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/252,847

(22) Filed: Sep. 20, 2002

(51) Int. Cl. H04N 5/225

(52) U.S. Cl. 348/207.1

(57) ABSTRACT

Disclosed is an image capturing system comprising a plurality of image capturing devices, a controller circuit for recognizing the orientation of a subject, and determining, based upon the recognition of the orientation of the subject, which of a plurality image capturing devices should be activated at any given time.

### CROSS-REFERENCE TO RELATED APPLICATIONS

The present application is related to commonly assigned U.S. Patent Application Serial No. [Attorney Docket No. 10018893-1] entitled “SYSTEM AND METHOD FOR CONTROLLING SERVICE DELIVERY,” U.S. Patent Application Serial No. [Attorney Docket No. 10018884-1] entitled “SYSTEM AND METHOD FOR MONITORING WITHIN A VEHICLE” and U.S. Patent Application Serial No. [Attorney Docket No. 10018886-1] “SYSTEM AND METHOD FOR WIRELESSLY VIEWING RESTRICTED DATA,” filed on the same date herewith, the disclosures of which are hereby incorporated by reference in their entireties.

### BACKGROUND

There are times when it is desired to arrange a camera, or other device, such that it always captures images in a specific orientation with respect to an individual, such as, for example, a child or an infant. For example, it may be desired to capture the images as seen by the subject as the subject changes orientations.

Such orientation can be achieved by mounting the camera on the head or body of the child as is sometime done with sports figures. It is now common place to mount a mini-camera on the helmet (cap, hat, skate, dashboard, puck, baseball, mask, etc) of a sports figure to capture images as seen by such sports figure as the orientation of the sports figure (car, boat, plane, house, ball) changes.

While cameras have become smaller and smaller, it is not practical to mount such a mini-camera on the head (leg, body) of an infant in order to view from afar (or take pictures of) that which is seen by the infant. It is also difficult to always be able to capture images of a child's face as the child moves about.

### SUMMARY

Embodiments of the teachings of the present invention provide an image recording system comprising a plurality of image capturing devices, a controller circuit for recognizing the orientation of a subject and for determining, based upon the recognition of the orientation of the subject, which one or more of the image capturing devices should be activated at any given time.

Additionally, embodiments of the teachings of the invention provide an image recording system comprising means for determining the orientation of an object to be recorded and means controlled by the determining means for enabling an image to be taken of the object in a selected orientation of the object.

### BRIEF DESCRIPTION OF THE DRAWINGS

FIG. 1 is a one embodiment of a system and method showing the teachings of the invention; and

FIG. 2 is a flow chart showing the operation of the embodiment of FIG. 1.

### DETAILED DESCRIPTION

The present inventive teachings are directed to a system and method which positions a group of cameras, or other image capturing devices, located away from the subject but arranged such that, by knowing the orientation of the subject at any given time, the proper camera can be activated, thereby capturing the image seen by the subject (or, if desired, the subject's face, back, side, etc.) based upon the orientation of the subject.

In one embodiment, sensors on the subject are used to determine orientation of the subject. In another embodiment, the image data from the subject is analyzed and the orientation is determined based upon the analyzed image.

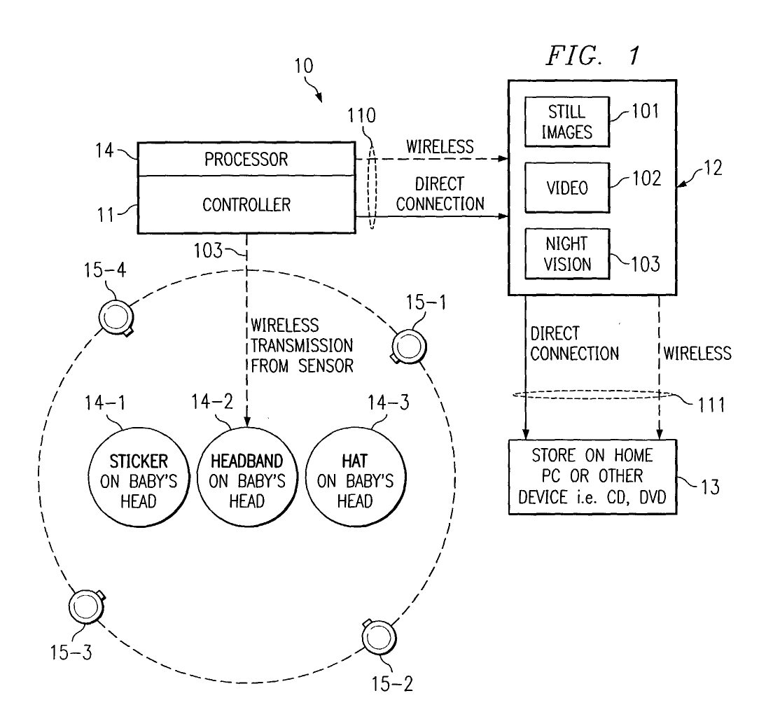

FIG. 1 shows one embodiment of a system and method showing the teachings of the invention where there is shown system 10 in which controller device 11 determines the orientation of a subject. Based on that orientation, video images of that subject are provided to capture device 12, under control of processor 14. These images could be still images 101, streaming video 102, or the like, such as night vision images 103. The images are communicated via connection 111 to a storage medium, such as a home PC, DVD, or other device (shown here as storage mechanism 13).

Note that connection 110 between controller 11 and capture device 12 could be any suitable link, such as may comprise a wireless or direct connection. Also connection 111 between capture device 12 and storage mechanism 13 could also be any suitable link, such as may comprise a wireless or direct connection. These connections could use 802.11 or Blue Tooth Protocols, if desired.

Connection 103 between controller 11 and a sensor such as sensors 14-1, 14-2, 14-3 on a subject could be via a wireless transmission device or devices positioned around a subject, such as video capture devices 15-1, 15-2, 15-3, 15-4. These devices could provide still video, streaming video, night vision, or any combination thereof, such as to correspond with the capabilities of capture device 12. There can be as many device positions in any configuration as desired. The configuration can be circular, square, triangular or any shape or topology.

According to one embodiment of the invention, it is desired to capture images as the subject would view that image. Thus, the system preferably knows in which direction the user is facing. Knowing that direction, then the proper image capturing device or devices, 15-1, 15-2, 15-3, and/or 15-4 is turned on under control of controller 11 working in cooperation with processor 14, to capture the image. Additionally or alternatively, as discussed above, it might be desirable to always take a picture of the facial expression of a subject regardless of the direction that the subject is facing, thereby activating different cameras facing head-on into the subject, as opposed to facing away from the subject.

Three embodiments of orientation sensors are shown in 14-1, 14-2 and 14-3, each of which uses a different mechanism. Device 14-1 utilizes a sticker on a baby's forehead which transmits, or reflects, a signal to/from device 11, perhaps via one or more of devices 15-1, 15-2, 15-3, and 15-4. Device 14-2 is a headband working as discussed for device 14-1 and device 14-3 is incorporated in a piece of clothing worn by the subject.

Devices 14-1, 14-2, 14-3 can be active transmission devices (radio, IR, V, sound, light) wherein these signals are detected by detectors (perhaps built into devices 15-1 to 15-4). Devices 15-1 to 15-4 could pick up reflected light images (perhaps enhanced, for example, by small mirrors, bezels, discontinuities and the like) of the subject wearing device 14-1, etc. Devices 14-1 through 14-3, could have particular shapes and/or sizes which can easily be compared to a known standard (shape, color, temperature, light spectrum, etc.) in any one of several well-known ways. The devices shown are for illustrative purposes only and any type of device could be used.

Also, if the subject assumes an unnatural position, as determined, for example, by comparison to a set of known “natural” positions as contained, for example, in controller 11, or a data base (not shown) associated with controller 11. This system can be programmed to provide a warning if an unnatural position is determined. The system could, if desired, provide indications of position changes by keeping track of the last known positions in a data base.

Processor 14 assists in the processing of the signal information and coordinates the sending and receiving of the wireless communication over links 103 and 110. Controller 11 can also communicate over link 110 to devices 12 or 13. Processor 14 could also operate to capture the image from the various video capture devices and to search that image for data that matches what is desired. For example, if it is desired to always view a facial expression of a child, the software in processor 14 (or in a data base, not shown) could be designed to look for facial characteristics in a captured image that come closest to matching prior/predefined facial attributes.

Once controller 11 determines which camera to use, that camera is activated, either continuously or periodically, and the images are transmitted to capture device 12 for processing, by a processor in device 12 or by processor 14. This processing could be, for example, digital imaging, which could include sizing, cropping, etc. The processed imaged are sent to storage device 13.

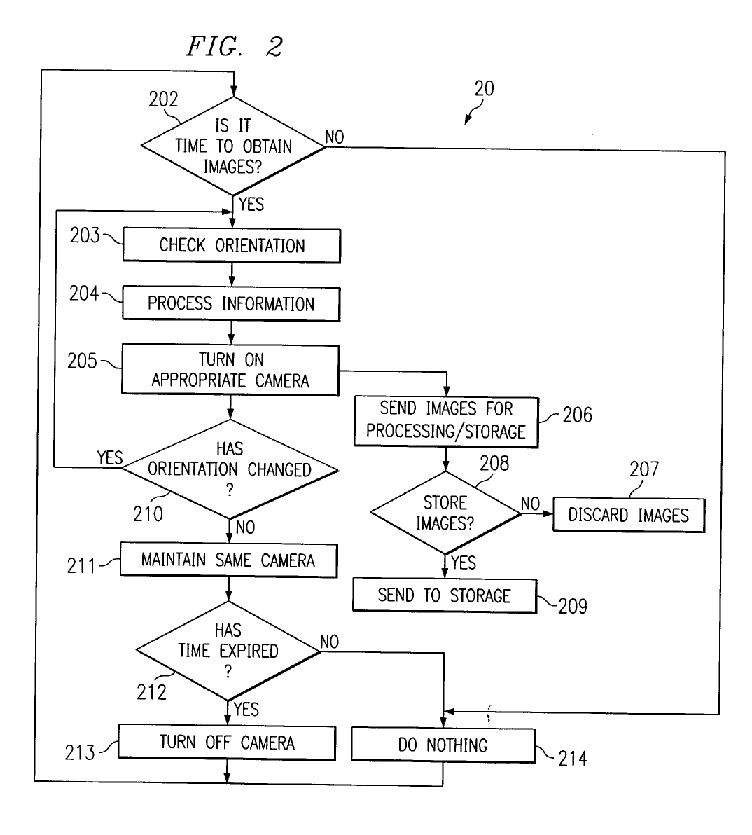

FIG. 2 is a flow chart 20 showing the operation of the embodiment of FIG. 1 where determination is made via process 202 that it is time to obtain an image. If the answer is no, then nothing is done until a next determination as to whether it is time to obtain images. If the answer is yes, then the orientation is checked as shown in process 203. Note that in some situations, the images are to be generated continuously and, therefore, different cameras may be selected as the subject's orientation changes. In this situation, the orientation may continuously be checked via process 203 without a determination as to a time to obtain images as described above with respect to process 202.

After the orientation is checked, the information, with respect to orientation, may be processed at process 204. This processing was discussed above using signals transmitted from (or to) the body of the subject. Also as discussed, processing can be done to determine the orientation of the subject from the actual captured images. In any event, process 205 turns on the appropriate camera, as may be determined from processing information with respect to orientation, and sends the images for processing and/or storage via process 206. A determination via process 208 is made as to whether the image should be stored or discarded. If discarded, the images are controlled by process 207. If stored, they are controlled by process 209.

After the appropriate camera is turned on, process 210 determines whether the orientation has changed. If it has not, then the same camera is maintained via process 211. A determination is then made, via process 212, as to whether the time for capturing images has expired. If time has expired, then the camera is turned off via process 213. If, however, the time for capturing images has not expired, then nothing is done (process 214) to change the operation until a next determination that the orientation has changed (process 210) and/or that the time for capturing images has expired (process 212). Following processes 213 or 214 the system restarts via process 202.

If the orientation has changed, as determined by process 210, then the cycle repeats via process 203.

What is claimed is:

1. An image capture system, said system comprising:
a plurality of image capturing devices; and
a controller for recognizing the orientation of a subject and selecting, based upon the recognition of the orientation of said subject, which of said image capturing devices should be activated at any given time.

2. The system of claim 1 wherein said controller locates a shape mounted on said subject.

3. The system of claim 1 wherein said controller locates a signal sent from said subject.

4. The system of claim 1 wherein said controller examines data obtained from an image of said subject.

5. The system of claim 4 wherein said controller matches said examined data against pre-defined information.

6. The system of claim 5 wherein said pre-defined information includes facial features.

7. The system of claim 1 further including:
means for enabling, from time to time, the activation of at least one of said image capturing devices.

8. The system of claim 7 wherein said controller locates a shape mounted on said subject.

9. The system of claim 7 wherein said controller locates a signal sent from said subject.

10. The system of claim 7 wherein said controller examines an image of said subject, said examination yielding known shapes.

11. The system of claim 7 wherein said known shapes are features of a child.

12. The system of claim 7 wherein said features are facial features.

13. A method for capturing images, said method comprising:
determining the orientation of an object to be captured; and
enabling, based on said determining, an image to be captured of said object in a particular orientation of said object.

14. The method of claim 13 further including selecting said orientation.

15. The method of claim 14 wherein said selecting includes determining a change in orientation of said object.

16. The method of claim 14 wherein said selecting includes determining an unnatural orientation of said object.

17. The method of claim 13 wherein said object is a human.

18. The method of claim 17 wherein said determining is a signal obtained from said human.

19. The method of claim 18 wherein said signal includes features of said human.

20. The method of claim 18 wherein said signal includes information to identify said human.

21. The control circuit of claim 7 wherein said features are facial features.

22. An image capturing system comprising:
means for determining the orientation of an object to be captured; and
means controlled by said determining means for enabling an image to be captured of said object in a selected orientation of said object.

23. The image capturing system of claim 22 further including means for selecting said orientation.

24. The image capturing system of claim 23 wherein said last-mentioned means includes means for determining a change in orientation of said object.

25. The image capturing system of claim 23 wherein said last-mentioned means includes means for determining an unnatural orientation of said object.

26. The image capturing system of claim 22 wherein said object is a human.

27. The image capturing system of claim 22 wherein said orientation determining means is a signal returned from said human.

28. The image capturing system of claim 23 wherein said signal includes features of said human.

29. The image capturing system of claim 23 wherein said signal includes enough information to identify said human.
